(19) United States
(12) Patent Application Publication
(10) Pub. No.: US 2011/0070137 A1
(43) Pub. Date: Mar. 24, 2011

(54) METHOD OF MANAGING CARBON DIOXIDE EMISSIONS

(76) Inventors: Dana Brock, Sebastopol, CA (US); Michael H. Kobler, Sebastopol, CA (US); John David Watson, Evergreen, CO (US)

(21) Appl. No.: 12/786,272

(22) Filed: May 24, 2010

Related U.S. Application Data
(60) Provisional application No. 61/180,660, filed on May 22, 2009.

(51) Int. Cl. B01D 53/62; B01J 19/00; F15D 1/00

(52) U.S. Cl. 423/232; 422/162; 137/1

(57) ABSTRACT

Processes are disclosed for managing the reduction of carbon dioxide emissions by a process of mining, acquiring water, capturing carbon and disposing of water containing bicarbonates. A number of process configurations of accelerated weathering of carbonate mineral-containing materials (AWC) reactors are disclosed.

### CROSS REFERENCE TO RELATED APPLICATION

The present application claims the benefits, under 35 U.S.C.§119(e), of U.S. Provisional Application Ser. No. 61/180,660 entitled “Method of Managing Carbon Dioxide Emissions”, filed May 22, 2009, which is incorporated herein by this reference.

### FIELD

The present invention relates generally to a method and means of managing the reduction of carbon dioxide emissions by a process of mining, acquiring water, capturing carbon and disposing of water containing calcium bicarbonates.

### BACKGROUND

Many industrial operations are powered by hydrocarbon fuels which generate flue gases that are comprised primarily of carbon dioxide, water vapor, sulphur dioxide and NOx emissions. The sulphur dioxide and NOx emissions may be reduced by well known pre- and post-combustion processes in which carbon dioxide is captured. Carbon dioxide emissions are typically not always removed from flue gases, although pre- and post-combustion methods for removing at least some of the carbon dioxide emissions are being implemented on many hydrocarbon powered industrial operations.

Rau et al have proposed an accelerated weathering of limestone (“AWL”) process as an economical method of removing carbon dioxide from flue gases as described, for example, in “Reducing Energy-Related CO2 Emissions Using Accelerated Weathering of Limestone”, G. H. Rau, K. G. Knauss, W. H. Langer, K. Caldeira, Energy 32, 2007. In the AWL process, carbon dioxide is combined with crushed limestone in water to produce a calcium bicarbonate solution. This solution can be diluted with additional water and sequestered in the ocean.

Rau proposes to use waste limestone fines from existing limestone mines and quarries for his AWL reactors. This limits the AWL technology to applications where limestone fines are available and requires AWL installations that are nearby to large sources of water to dilute the calcium bicarbonate solutions formed in AWL reactors to levels of alkalinity acceptable for disposal into these near by bodies of water.

There remains a need for more general methods of applying the AWL process to hydrocarbon-powered industrial operations that may or may not be sited near large bodies of surface or underground water or near sources of limestone.

### SUMMARY

These and other needs are addressed by the various embodiments and configurations of the present invention which are directed generally to providing sources of large quantities of carbonate mineral-containing materials and methods of sequestering calcium bicarbonate solutions.

In one embodiment, a method is provided that includes the steps of:

(a) receiving, from a hydrocarbon-powered industrial operation, a carbon dioxide-containing off-gas;

(b) contacting the off-gas with water and an underground supply of carbonate mineral-containing materials to convert at least a portion of the carbon dioxide and carbonate mineral-containing materials into aqueous bicarbonate and a treated off-gas; and

(c) discharging the treated off-gas.

In another embodiment, a system is provided that includes:

(a) a supply of carbonate mineral-containing materials;

(b) an inlet for a carbon dioxide-containing off-gas from a hydrocarbon-powered industrial operation, the hydrocarbon-powered industrial operation converting hydrocarbons into the off-gas;

(c) an accelerated weathering of carbonate mineral-containing materials (“AWC”) reactor to contact the off-gas with water and carbonate mineral-containing materials to convert at least a portion of the carbon dioxide and carbonate mineral-containing materials into aqueous bicarbonates and a treated off-gas, the AWC reactor being positioned underground; and

(d) an outlet to discharge the treated off-gas.

In another embodiment, a reactor assembly is provided that includes:

(a) a first zone to contact water with a carbon dioxide-containing off-gas to dissolve at least most of the carbon dioxide in the water to form a treated off-gas and an aqueous process stream comprising dissolved carbon dioxide in the form of carbonic acid, the first zone being substantially free of carbonate mineral-containing materials; and

(b) a second zone to contact the process stream with carbonate mineral-containing materials to convert at least most of the carbonic acid to bicarbonates and form aqueous bicarbonates, wherein the first and second zones are spatially dislocated from one another.

In another embodiment, a method is provided that includes the steps of:

(a) in a first zone, contacting water with a carbon dioxide-containing off-gas to dissolve at least most of the carbon dioxide in the water to form a treated off-gas and an aqueous process stream comprising dissolved carbon dioxide in the form of carbonic acid, the first zone being substantially free of carbonate mineral-containing materials; and

(b) in a second zone, contacting the process stream with carbonate mineral-containing materials to convert at least most of the carbonic acid to bicarbonates and form aqueous bicarbonates, wherein the first and second zones are spatially dislocated from one another.

In one configuration, the AWC process is a two-step process by two reactors, one which dissolves off-gases in water and a second which converts dissolved carbon dioxide to calcium bicarbonate by the addition of crushed limestone and limestone fines.

In yet another embodiment, a method is provided that includes the steps of:

(a) at high tide, collecting seawater in at least a first excavation;

(b) at low tide, removing the collected seawater from the at least a first excavation;

(c) processing the seawater to form a discharge stream; and

(d) at low tide, locating the discharge stream in the at least a first excavation, whereby, at high tide, the discharge stream is removed from the at least a first excavation.

In another embodiment, a system is provided that includes:

(a) at least a first underground excavation operable, at high tide, to collect seawater; and

(b) a facility operable, at low tide, to remove the collected seawater from the at least a first excavation; process the seawater to form a discharge stream; and locate the discharge stream in the at least a first excavation, whereby, at high tide, the discharge stream is removed from the at least a first excavation.

In one configuration, an AWC facility is sited underground, near an ocean, so that the action of the tides coming in and going out are used to move water into the AWL reactor facility and then dilute and flush out the resulting calcium bicarbonate solution.

In one configuration, a carbonate (e.g., carbonate or dolomite) mine is sited near a hydrocarbon-powered industrial operation such as, for example, a power plant, a cement production plant, a steel production plant, or a thermal hydrocarbon recovery operation. The carbonate rock is used for several purposes such as supplying commercial aggregate, water softening, sulphur and carbon dioxide removal from the combustion of hydrocarbon fuels. Captured carbon dioxide can converted to bicarbonates (e.g., calcium bicarbonate) by an AWC reactor system and can be sequestered in a mined out section of the mine. In this configuration, large amounts of water required for diluting bicarbonate solutions formed in AWC reactors may be unnecessary as the underground reactor can use modest sources of local water or nearby aquifers to dilute, disperse and sequester the bicarbonates.

In another configuration, a carbonate mine is sited near a hydrocarbon-powered industrial operation. Captured carbon dioxide is converted to bicarbonates using an AWC process in which the AWC reactor is sited in an excavated cavern where the carbon capture reaction takes place and the resulting bicarbonate solution is sequestered. A portion of the captured carbon dioxide may also be sequestered in a mined out section of the limestone mine. In this configuration, large amounts of water required for diluting bicarbonate solutions formed in AWC reactors may not be necessary as the underground reactor can use modest sources of local water or nearby aquifers to dilute, disperse and sequester the bicarbonate.

In yet another configuration, a carbonate mine is sited near a hydrocarbon-powered industrial operation. Captured carbon dioxide is converted to calcium bicarbonate using an AWC process. In this configuration the AWC reactor is created in-situ by rubblizing in place long chambers in the carbonate formation by use of explosives or a tunnel boring machine. The rubblized chamber is where water and flue gas are introduced, the carbon capture reaction takes place, and from which the resulting bicarbonate solution is generated, collected and then injected into saline aquifers directly below the chambers. In this configuration, large amounts of water required for diluting bicarbonate solutions formed in AWC reactors may not be necessary as the underground reactor can use modest sources of local water or nearby saline aquifers to dilute, disperse and sequester the bicarbonate.

In a further embodiment, a method is disclosed for disposing of carbon dioxide captured by conventional methods by transporting the carbon dioxide from a remote location to an underground AWC facility sited near an ocean, where it can be converted to bicarbonate, diluted, and sequestered directly in the ocean.

The above-described embodiments and configurations are neither complete nor exhaustive. As will be appreciated, other embodiments of the invention are possible utilizing, alone or in combination, one or more of the features set forth above or described in detail below.

The following definitions are used herein:

The terms “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

AWL means accelerated weathering of limestone. In this process gases containing carbon dioxide are dissolved in a solution of water and crushed limestone and limestone fines. A portion of the dissolved carbon dioxide is converted to calcium bicarbonate.

AWC means accelerated weathering of carbonate mineral-containing materials. In this process gases containing carbon dioxide are dissolved in a solution of water and crushed carbonate mineral-containing materials and carbonate mineral-containing materials fines. A portion of the dissolved carbon dioxide is converted to a bicarbonate.

A carbon sequestration facility is a facility in which carbon dioxide can be controlled and sequestered in a repository such as, for example, by introduction into a mature or depleted oil and gas reservoir, an unmineable coal seam, a deep saline formation, a basalt formation, a shale formation, or an excavated tunnel or cavern.

Carbonate rocks are a class of sedimentary rocks composed primarily of one or more categories of carbonate minerals. The two major types of carbonate rocks are limestone and dolomite, composed primarily of calcite (CaCO₃) and the mineral dolomite (CaMg(CO₃)₂), respectively. Chalk and tufa are also minor sedimentary carbonates. Examples of carbonate minerals include without limitation calcite, dolomite, siderite, magnesite, ankerite, aragonite, azurite and malachite.

It is to be understood that a reference to “limestone” herein is intended to include limestone, dolomite, peridotite, chalk, tufa, and other naturally occurring rocks that are known to absorb carbon dioxide.

### BRIEF DESCRIPTION OF THE DRAWINGS

FIG. 1 is a schematic of a AWL reactor which is prior art.

FIG. 2 is a schematic of a two-stage AWL reactor.

FIG. 3 is a schematic of a prior art industrial operation wherein CO2 is removed by conventional means.

FIG. 4 is a schematic of an industrial operation wherein CO2 is removed by an AWL process.

FIG. 5 is a schematic of an industrial operation wherein CO2 is removed by an AWL process in an excavated cavern.

FIG. 6 is a schematic of a prior art barge-based AWL reactor operation.

FIG. 7 is a schematic of a prior art AWL reactor operation using a surface reservoir.

FIG. 8 is a schematic of a two-stage AWL reactor operation using an underground reservoir.

FIG. 9 is a schematic of an AWL reactor operation using an in-situ reactor.

FIG. 10 is a plan view of a two-stage AWL reactor operation using tidal action.

FIG. 11 is a side view of an AWL reactor facility at high tide.

FIG. 12 is a side view of an AWL reactor facility at low tide.

FIG. 13 is a schematic of a prior art system for disposing of previously captured carbon dioxide.

FIG. 14 is a schematic of an AWL system for disposing of previously captured carbon dioxide.

### DETAILED DESCRIPTION

Accelerated Weathering of Limestone or AWL is a process for reducing or eliminating carbon dioxide emissions is based on the reaction:

CO₂+H₂O+CaCO₃ Ca+2(HCO₃)

where the calcium and bicarbonate ions form calcium bicarbonate in solution with water.

This reaction can be carried out in a water-filled reactor in which crushed limestone and limestone fines are filtered down through the water. Flue gases are injected at any one or all of multiple locations around the reactor. In addition to carbonic acid, the presence of sulphur in the solution (as weak sulphuric acid) enhances the carbon dioxide capture reaction rate. The sulphur may be captured by also introducing lime to the reactor.

As can be appreciated, limestone, CaCO₃, contains the potential for releasing fossil carbon dioxide (for example in the production of lime for cement). In the AWL reaction, this potential carbon dioxide is never released but is combined with previously released carbon dioxide to form calcium bicarbonate which incorporates the potential carbon dioxide molecule from limestone with a new carbon dioxide molecule contained in a flue gas or as previously captured carbon dioxide.

### AWL Reactors

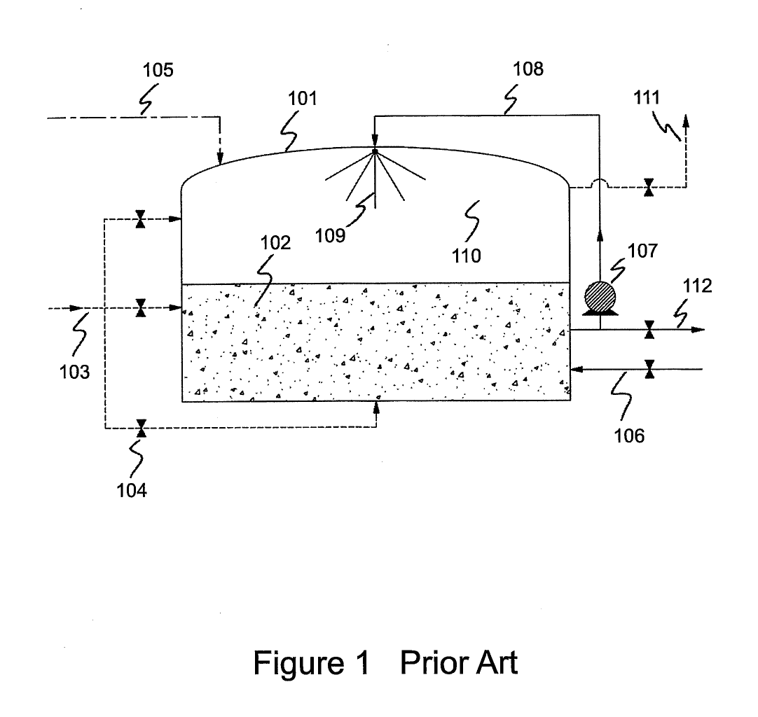

FIG. 1 is a schematic of a prior art AWL reactor. Such a reactor is described in “Accelerated Weathering of Limestone for CO₂ Mitigation: Opportunities for the Stone and Cement Industries”, Langer, San Juan, Rau, and Caldeira, Mining Engineering, February 2009.

In FIG. 1, crushed limestone and limestone fines are added to the reactor 101 via conduit 105 (limestone conduits denoted by dash-dot lines). Untreated ocean, lake or river water is added to the reactor 101 via conduit 106 (water conduits denoted by solid lines) until the carbonate bed 102 reaches a predetermined mixture of water and limestone. Incoming flue gases are injected into the AWL reactor 101 via conduits 103 (gas conduits denoted by dashed lines) at multiple points such as into the gas volume 110 of the reactor, into the middle of the reactor carbonate bed 102 or into the bottom of the reactor carbonate bed 102. Gas volume 110 is comprised of a mixture of air and flue gases. After a selected residence time, a first portion of water containing a calcium bicarbonate solution is removed from the carbonate bed 102 and pumped with pump 107 through conduit 108 to the top of reactor 101 where it is recycled by spraying 109 into the gas volume 110. A second portion of water containing a calcium bicarbonate solution is removed from the carbonate bed 102 and sent via conduit 112 for further dilution and sequestering in a nearby ocean, lake or river. The flue gases with a substantial portion of the carbon dioxide removed via conversion to calcium bicarbonate are discharged via conduit 111 into the atmosphere. As can be appreciated, valves such as 104 are used to control the flow of input and output gases as well as input and output water.

The fraction of carbon dioxide removed is dependent on the ratio of reactor water flow rate to gas flow rate. Both flow rates are expressed in the same volume per time units. As this ratio increases, more carbon dioxide is converted to calcium bi-carbonate. For example, for a ratio of about 1, about 60% of the carbon dioxide introduced into the reactor is converted to calcium bicarbonate. For a ratio of about 8, about 95% of the carbon dioxide introduced into the reactor is converted to calcium bicarbonate.

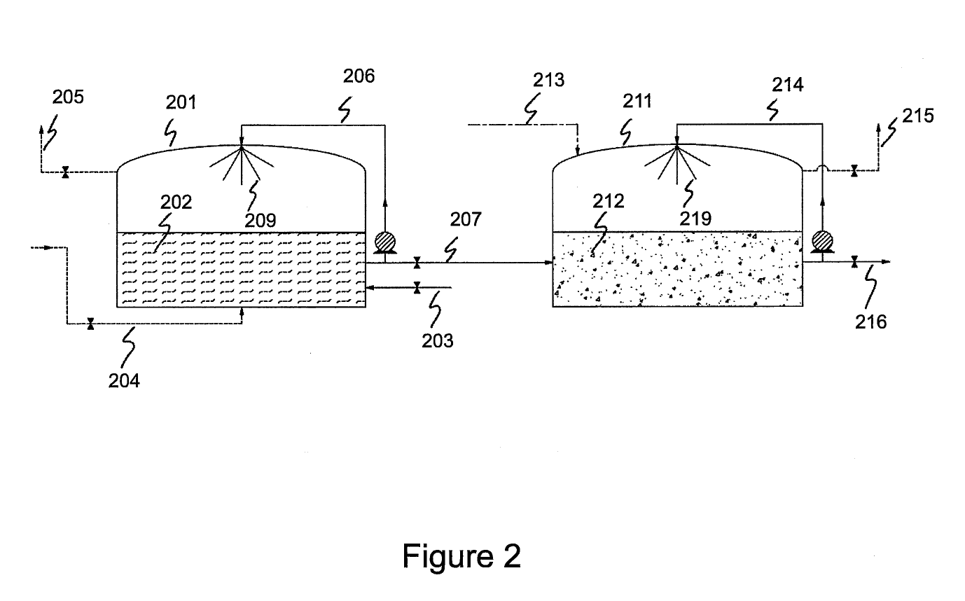

FIG. 2 is a schematic of a two-stage AWL reactor in which a first reactor 201 is used to dissolve flue gases in water and a second reactor 211 is used to carry out the reaction whereby calcium and bicarbonate ions form calcium bicarbonate in solution with water. Untreated ocean, lake or river water is added to reactor 201 via conduit 203. Flue gases are introduced into water reactor 201 via conduit 204 where they dissolve in the water mass 202 to form a carbonic acid solution. A vent to the atmosphere 205 is provided to relieve the pressure in the event of a pressure buildup. A first portion of water containing dissolved flue gases is removed from the water mass 202 and pumped through conduit 206 to the top of reactor 201 where it is sprayed 209 into the gas volume above water mass 202. A second portion of water containing dissolved flue gases is removed from reactor 201 and sent via conduit 207 to the second reactor 211. Crushed limestone and limestone fines are added to the reactor 211 via conduit 213 as needed. A first portion of water containing a calcium bicarbonate solution is removed from the carbonate bed 212 and pumped via conduit 214 to the top of reactor 211 where it is sprayed 219 into the gas volume. A second portion of water containing a calcium bicarbonate solution is removed from the carbonate bed 212 and sent via conduit 216 for further dilution and sequestering in a nearby ocean, lake or river. The flue gases with a substantial portion of the carbon dioxide removed via the solution are discharged via conduit 215 into the atmosphere. As can be appreciated, valves are used to control the flow of input and output gases as well as input and output water.

### Flow Charts of Processes

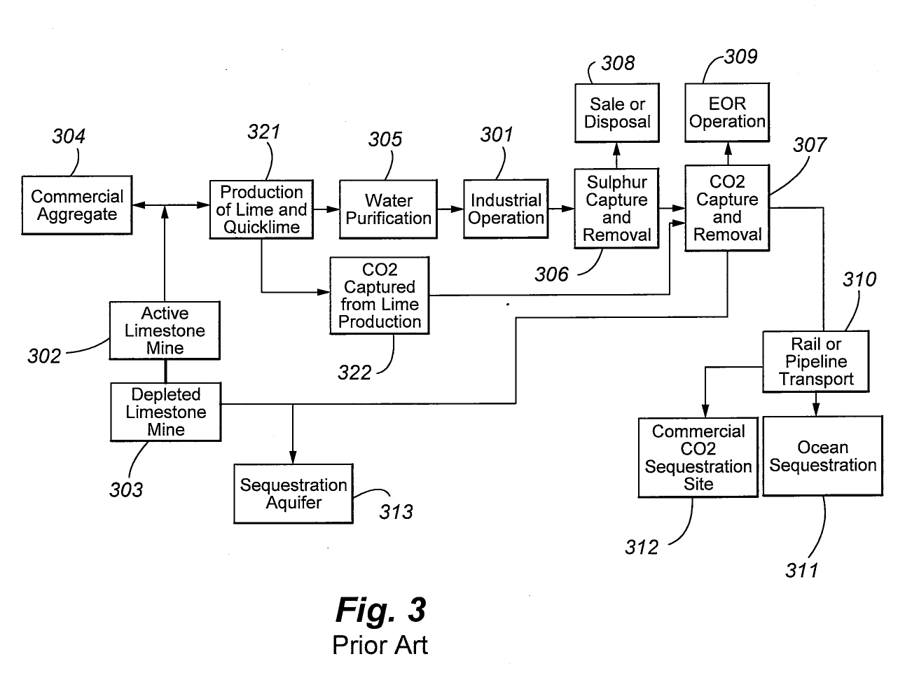

FIG. 3 is a schematic of a prior art industrial operation 301 wherein carbon dioxide CO₂ is removed by conventional means based on the use of delivered limestone. In this configuration, a limestone mine 302 is installed in a limestone or dolomite formation near an industrial operation 301 which generates significant amounts of carbon dioxide. By siting a limestone mine 302 near the industrial operation 301, the cost of limestone is minimized by avoiding significant transportation costs. Examples of such industrial operations include electrical power plants using hydrocarbon fuels, thermal bitumen or heavy oil recovery operations, cement plants and the like. A portion of the mined limestone may be used or sold for commercial aggregate 304. The remainder of the mined limestone may be used for water purification 305, sulphur capture and removal 306 and carbon dioxide capture and removal 307. Water softening 305 is typically carried out before use in the industrial operation 301. Reduction of hardness involves the addition of slaked lime Ca(OH)₂ to a hard water supply to remove the carbonate hardness by precipitation and filtration through the basic reaction:

Ca(OH)₂+Ca(HC0₃)₂ 2 CaCO₃+2 H₂0

The mined limestone is processed 321 into lime CAO and slaked lime Ca(OH)₂ by well-known processes that liberate carbon dioxide CO₂. This “clean” carbon dioxide is considered fossil carbon dioxide and is captured 322 for future disposal. The lime is used in sulphur removal 306 and carbon dioxide removal 307 is carried out by any well-known processes such as pre-combustion, post-combustion, oxyfuel combustion or other industrial process such as ammonia production. Removal of sulphur can be carried out using lime to produce calcium sulphite CaSO₃ which, in turn, can be processed into gypsum which can be sold as a product or disposed 308. Disposal can be by returning the calcium sulphite slurry or gypsum for example to a mined out section 303 of the limestone mine 302. Carbon dioxide may be removed and captured 307 by using solid sorbents based on hydroxides of alkali metals such as for example calcium hydroxide Ca(OH)₂ activated with sodium hydroxide NaOH or potassium hydroxide KOH as represented by the summary reaction:

Ca(OH)₂+CO₂ CaCO₃+H₂O

As can be seen, the production of lime liberates “clean” carbon dioxide which can be captured. The use of slaked lime to capture carbon dioxide produced in the industrial operation 301 removes carbon dioxide from, for example, the burning of fossil fuels. Both the captured carbon dioxide 322 and the calcium carbonate and residual “dirty” carbon dioxide from step 307 must be disposed. The pure carbon dioxide captured from step 322 can be used or sold for Enhanced Oil Recovery (“EOR”) usage 309 or it can be transported by rail, truck or pipeline 310 and sequestered in the ocean 311 or at a commercial carbon dioxide sequestration site 312. Alternately, the clean carbon dioxide generated in the capture step 322 can be sequestered in a nearby aquifer 313 if conditions in the aquifer are acceptable. The calcium carbonate and residual “dirty” carbon dioxide from step 307 can be returned and disposed of in a mined out section 303 of the limestone mine 302.

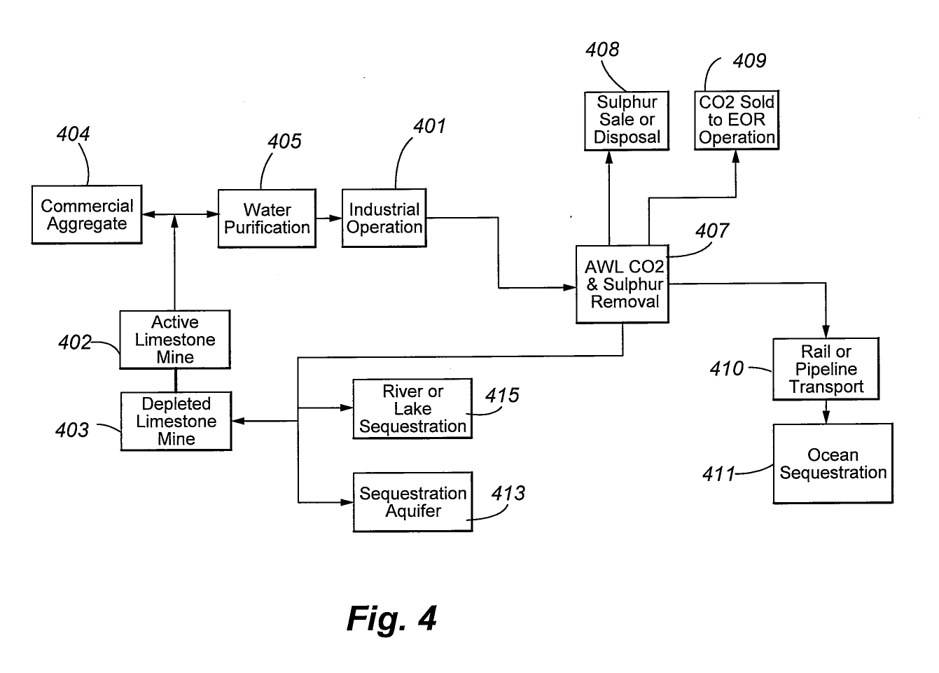

FIG. 4 is a schematic of an industrial operation wherein carbon dioxide CO2 is removed by an accelerated weathering of limestone (“AWL”) process based on the use of limestone. In this configuration, a limestone mine 402 is installed in a limestone or dolomite formation near an industrial operation 401 which generates significant amounts of carbon dioxide. By siting a limestone mine 402 near the industrial operation 401, the cost of limestone is minimized by avoiding significant transportation costs. Examples of such industrial operations include electrical power plants using hydrocarbon fuels, thermal bitumen or heavy oil recovery operations, cement plants and the like. A portion of the mined limestone may be used or sold for commercial aggregate 404. The remainder of the mined limestone may be used for water purification 405, sulphur capture and removal and carbon dioxide capture and removal 407 using the AWL process on the flue gases generated by the industrial operation 401.

Accelerated Weathering of Limestone or AWL is a process for reducing or eliminating carbon dioxide emissions is based on the reaction:

CO₂+H₂O+CaCO₃ Ca+2(HCO₃)

where the calcium and bicarbonate ions form calcium bicarbonate in solution with water.

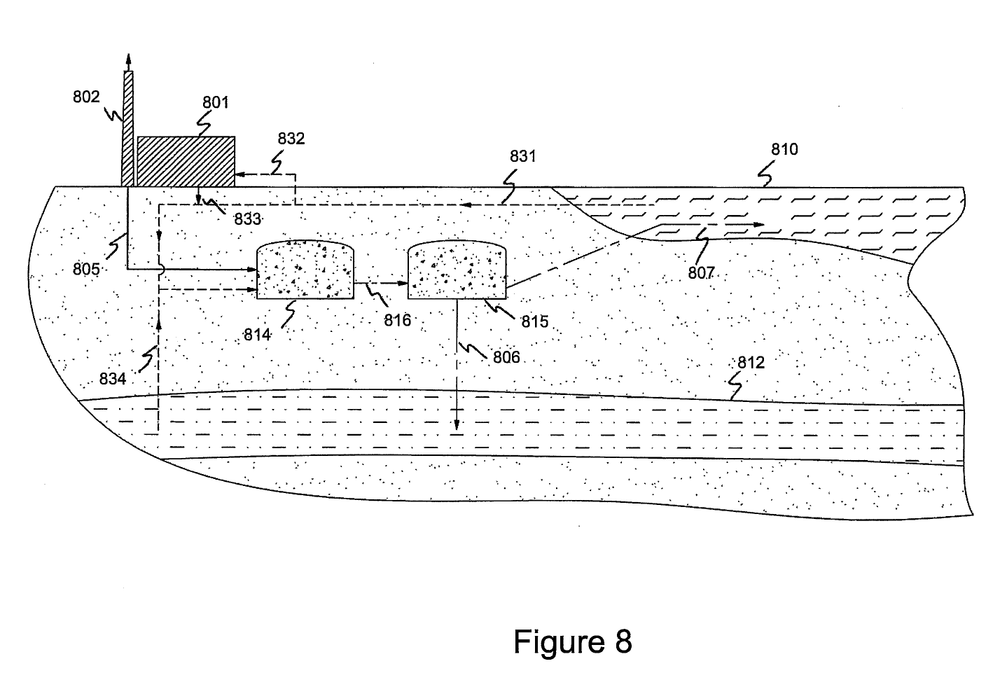

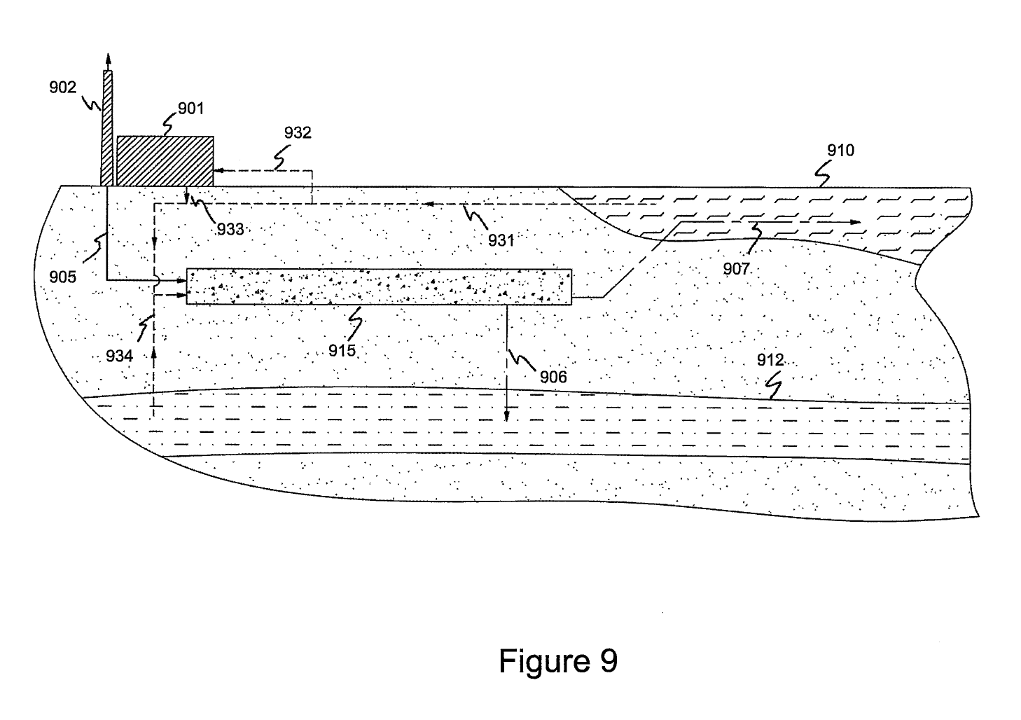

This reaction is carried out in a water filled reactor in which crushed limestone is filtered down through the water and flue gases are injected at multiple locations around the reactor. In addition to carbonic acid, the presence of sulphur in the solution (as weak sulphuric acid) enhances the carbon dioxide capture reaction rate. The sulphur may be captured by also introducing lime to the reactor. An AWL reactor is discussed in more detail in FIG. 1. The AWL process could be carried out in a large water reservoir in an open excavation, a portion of which may be used for the actual AWL reactor. Such a reservoir would be sited near the industrial operation 401. The AWL reactor can also be sited underground as described in FIGS. 8 and 9.

The sulphur from the AWL reactor 407 can be captured, disposed of or sold. If desired, a portion of the calcium bicarbonate can be turned into calcium and carbon dioxide by allowing a portion of the calcium bicarbonate solution to evaporate and capturing the CO₂ to be used for sale or EOR operations 409.

If economical, the calcium bicarbonate solution can be diluted with water and sent by rail, truck or pipeline 410 for disposal in the ocean 411. Alternately, the calcium bicarbonate solution can be diluted with water and sequestered in a river or lake 415 or in a nearby aquifer 413. The amount of water required to dilute the calcium bicarbonate solution from reactor 407 varies depending on the final destination. For example, a calcium bicarbonate solution may require as much as about 10,000 tons of water per ton of carbon dioxide to dispose of the resulting solution in a large river or large lake. Less dilution may be required for disposal in an aquifer. Even less dilution would be required for rail, truck or pipeline transportation. The calcium bicarbonate solution may not be required to be substantially diluted for disposal in some aquifers 413 or for disposal in a mined out section 403 of the limestone mine 402.

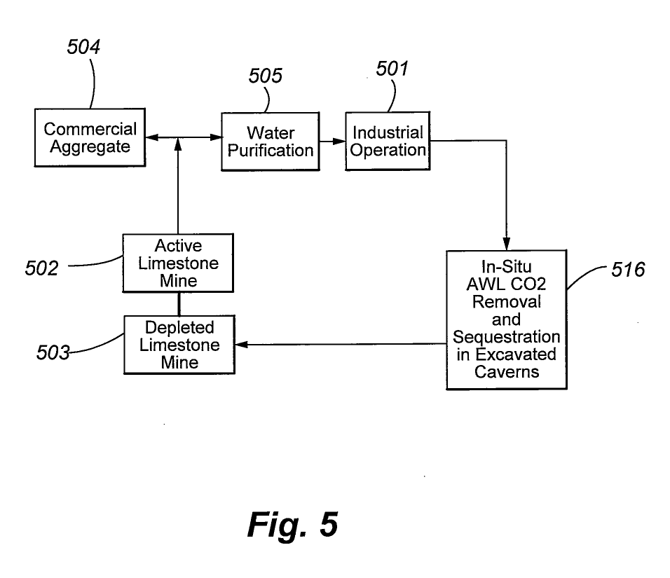

FIG. 5 is a schematic of an industrial operation wherein CO2 is removed by an AWL process in an excavated cavern. In this configuration, a limestone mine 502 is installed in a limestone or dolomite formation near an industrial operation 501 which generates significant amounts of carbon dioxide. By siting a limestone mine 502 near the industrial operation 501, the cost of limestone is minimized by avoiding significant transportation costs. Examples of such industrial operations include electrical power plants using hydrocarbon fuels, thermal bitumen or heavy oil recovery operations, cement plants and the like. A portion of the mined limestone may be used or sold for commercial aggregate 504. The remainder of the mined limestone may be used for water purification 505. The flue gases from the industrial operation 501 are then directed to an underground cavern which serves as a large AWL reactor 516 for sulphur capture and carbon dioxide capture. The cavern 516 may be divided into chambers and a portion of the resulting calcium bicarbonate solution may be transported to a mined out section 503 of the limestone mine 502. The advantage of this configuration is that a minimum of additional water is required to keep the calcium bicarbonate solution from evaporating and releasing gaseous carbon dioxide in the underground cavern.

### AWL Carbon Capture Configurations

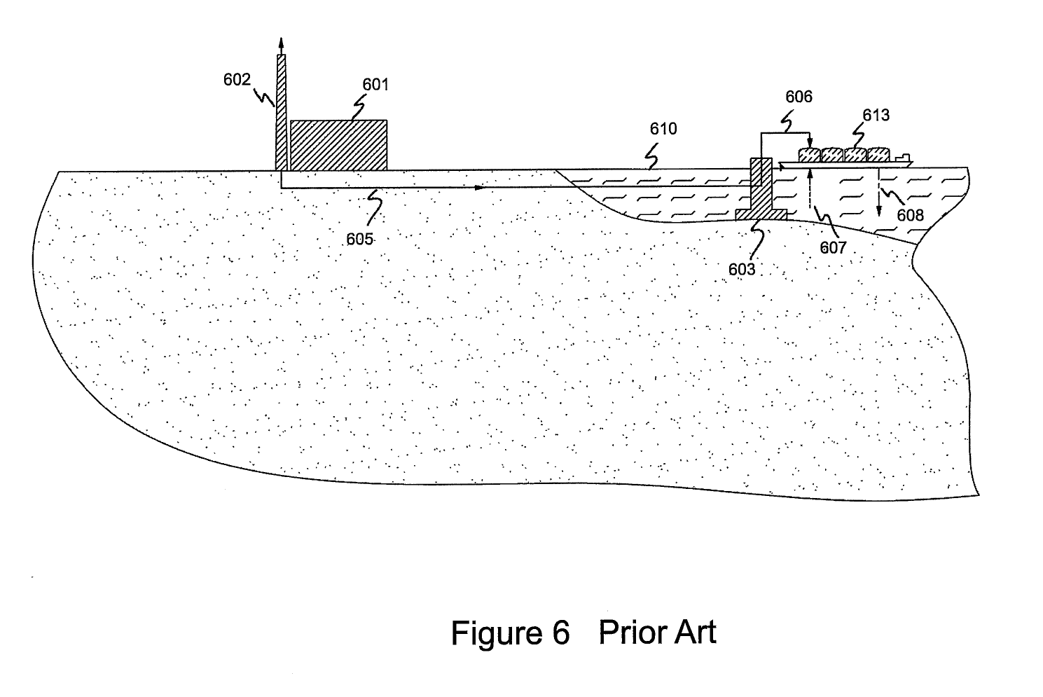

FIG. 6 is a schematic of a prior art barge-based AWL reactor operation. Such an approach was suggested in “Reducing Energy-Related CO2 Emissions Using Accelerated Weathering of Limestone”, G. H. Rau, K. G. Knauss, W. H. Langer, K. Caldeira, Energy 32, 2007. This figure shows an industrial plant 601 sited near a shoreline of a large body of water 610 such as for example an ocean, a large lake or a large river. For example, the industrial plant 601 may be a hydrocarbon fuel powered electrical power plant, a cement production plant or the like. The plant 601 is shown with a tall flue gas stack 602 which is normally used to dispose of flue gases into the atmosphere. Rather than disposing of flue gases into the atmosphere, the AWL process can be used to remove a substantial portion or all of the carbon dioxide from the flue gases. It is also possible to remove sulphur and NOxs from the flue gases in an AWL reactor. In FIG. 6, the AWL reactor is shown formed by a barge system. This system could, for example, be comprised of barges carrying limestone and some barges carrying AWL reactors. Such a barge system 613 could be moored off the shoreline near to industrial plant 601 using a mooring station 603. The flue gas paths are shown as continuous lines 605 and the water paths by dashed lines 607 and 608. The flue gases from plant 601 can be transported to the barge reactor system 613 via, for example, a pipeline 605 installed underground and through the body of water 610 to the mooring station 603 where it can be connected to another pipeline 606 which directs the flue gases into the barge-based reactors 613. Water from water body 610 is pumped in to the AWL reactors via inlet 607, mixed with crushed limestone stored in another nearby barge. A first product of the AWL reactors is a calcium bicarbonate solution which is then disposed of via outlet 608 into the body of water 610 as a diluted calcium bicarbonate aqueous solution. A second product of the AWL reactors are flue gases minus most of the carbon dioxide, sulphur and NOxs which can be vented from the AWL reactors into the surrounding atmosphere.

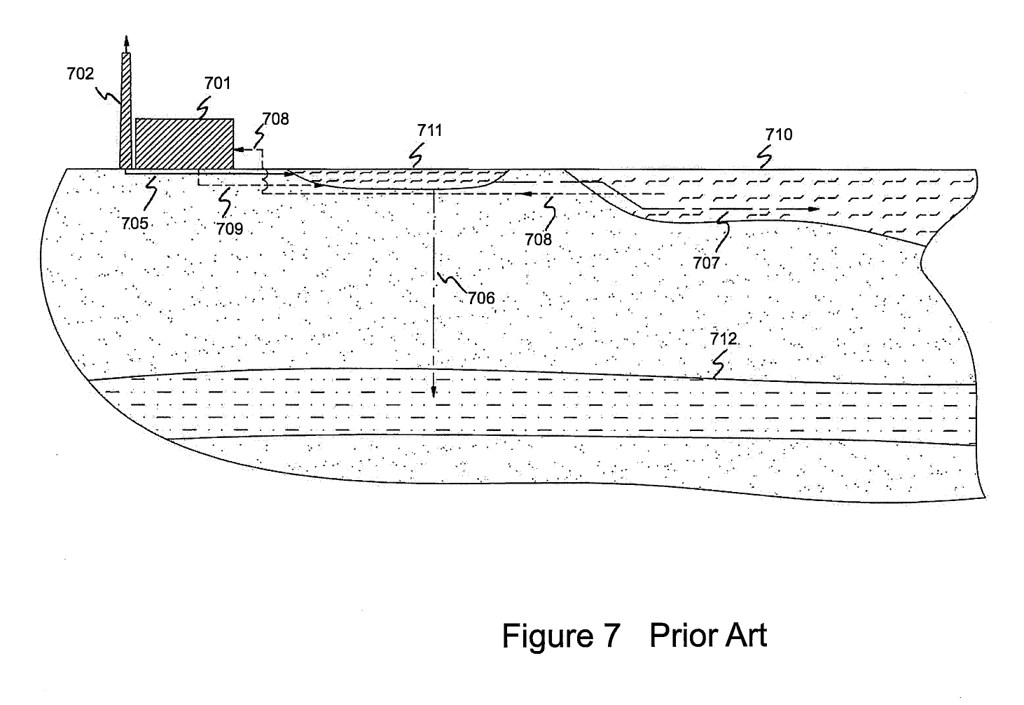

FIG. 7 is a schematic of a prior art AWL reactor operation using a surface reservoir. This figure shows an industrial plant 701 sited near a shoreline of a large body of water 710 such as for example an ocean, a large lake or a large river. For example, the industrial plant 701 may be a hydrocarbon fuel powered electrical power plant, a cement production plant or the like. The plant 701 is shown with a tall flue gas stack 702 which is normally used to dispose of flue gases into the atmosphere. Rather than disposing of flue gases into the atmosphere, the AWL process can be used to remove a substantial portion or all of the carbon dioxide from the flue gases. It is also possible to remove sulphur and NOxs from the flue gases in an AWL reactor. The flue gas paths are shown as continuous lines and the water paths by dashed lines. In FIG. 7, the AWL reactor is formed using a surface reservoir 711 such as described by item 507 in FIG. 5 into which flue gases are directed via pipeline 705. Water is often used for cooling in industrial plant operations. In this example, cooling water is taken from water body 710 via path 708 into plant 701 and used for cooling. The heated water is then piped via path 709 to AWL reservoir 711. Crushed limestone is added into reservoir 711 and a diluted calcium bicarbonate solution is transported out of reservoir 711 via a second pipeline for disposal into a nearby body of water 710. A first product of the AWL reactor is a calcium bicarbonate solution which is disposed of via pipeline 707 into the body of water 710 as a diluted calcium bicarbonate solution. Alternately, the calcium bicarbonate solution can be disposed of via well 706 into a saline aquifer 712, if available, typically as a less diluted calcium bicarbonate solution. A second product of the AWL reactor is flue gases minus most of the carbon dioxide, sulphur and NOxs which can be allowed to vent from the AWL reactor into the surrounding atmosphere.

As can be appreciated, two surface reservoirs can be used where a first reservoir is used to dissolve flue gases in water and a second reservoir is used to carry out the reaction whereby calcium and bicarbonate ions form calcium bicarbonate in solution with water.

FIG. 8 is a schematic of a two-stage AWL reactor operation using underground reservoirs. This figure shows an industrial plant 801 sited near a shoreline of a large body of water 810 such as for example an ocean, a large lake or a large river. For example, the industrial plant 801 may be a hydrocarbon fuel powered electrical power plant, a cement production plant or the like. The plant 801 is shown with a tall flue gas stack 802 which is normally used to dispose of flue gases into the atmosphere. Rather than disposing of flue gases into the atmosphere, the AWL process can be used to remove a substantial portion or all of the carbon dioxide from the flue gases. It is also possible to remove sulphur and NOxs from the flue gases in an AWL reactor. The flue gas paths are shown as continuous lines and the water paths by dashed lines. In FIG. 8, the AWL reactor is formed using two underground caverns 814 and 815 such as described in FIG. 2 into which flue gases are directed via pipeline 805. Water is often used for cooling in industrial plant operations. In this example, cooling water is taken from water body 810 via path 831 and 832 into plant 801 and used for cooling. The heated water from plant 801 is then piped via path 833 to a first reactor 814 used to dissolve flue gases in water. This water is then directed via pipeline 816 to a second reactor 815 used to carry out the reaction whereby calcium and bicarbonate ions form calcium bicarbonate in solution with water. Water for the reactor 814 may also be taken from aquifer 812 if available, via path 834 which may be a well or series of wells. Alternately, water for reactor 814 may be taken directly from the body of water 810 via path 831. Crushed limestone is also added into underground reactor 815 and a diluted calcium bicarbonate solution is transported out of underground reservoir 815 via a second pipeline 807 for disposal into a nearby body of water 810. Alternately or in addition, a diluted calcium bicarbonate solution may be sequestered via a well or wells 806 for disposal into an aquifer 812. A first product of the AWL reactor is a calcium bicarbonate solution which is disposed of via pipeline 1107 into the body of water 810 and or via disposal wells 806 into an aquifer 812 as a diluted calcium bicarbonate solution. A second product of the AWL reactor is flue gases minus most of the carbon dioxide, sulphur and NOxs which can be vented from the underground AWL reactor 815 into the surrounding atmosphere.

FIG. 9 is a schematic of an AWL reactor operation using an in-situ reactor. Such an in-situ AWL reactor 915 can be formed in-situ by rubblizing long chambers in an underground limestone formation using drill & blast, a tunnel boring machine, a roadheader machine or another excavation method. This figure shows an industrial plant 901 sited near a shoreline of a large body of water 910 such as for example an ocean, a large lake or a large river. For example, the industrial plant 901 may be a hydrocarbon fuel powered electrical power plant, a cement production plant or the like. The plant 901 is shown with a tall flue gas stack 902 which is normally used to dispose of flue gases into the atmosphere. Rather than disposing of flue gases into the atmosphere, an in situ AWL process can be used to remove a substantial portion or all of the carbon dioxide from the flue gases. The flue gas paths are shown as continuous lines and the water paths by dashed lines. Flue gases are injected into the rubblized limestone chambers via pipeline 905 and a diluted calcium bicarbonate solution reaction product is formed and either allowed to seep into the surrounding ground formations or is injected by a well or wells 906 into nearby saline aquifer 912. It is also possible to remove sulphur and NOxs from the flue gases in an AWL reactor so the flue gases minus most of the carbon dioxide, sulphur and NOxs can be vented back to the surface for dispersal into the surrounding atmosphere or left underground to dissipate into the surrounding formation. Water is often used for cooling in industrial plant operations. In this example, cooling water is taken from water body 910 via path 931 and 932 into plant 901 and used for cooling. The heated water from plant 901 is then piped via path 933 to AWL reactor 915. Water for the AWL reactor 915 may also be taken from aquifer 912 if available, via path 934 which may be a well or series of wells. Alternately, water for AWL reactor 915 may be taken directly from the body of water 910 via path 931. In FIG. 8, the AWL reactor is formed using an underground cavern 915 such as described by item 616 in FIG. 6 into which flue gases are directed via pipeline 905. A diluted calcium bicarbonate solution is transported out of underground in-situ reactor 915 via a second pipeline 907 for disposal into a nearby body of water 910. Alternately or in addition, a diluted calcium bicarbonate solution may be sequestered via a well or wells 906 for disposal into an aquifer 912. A first product of the AWL reactor is a calcium bicarbonate solution which is disposed of via pipeline 907 into the body of water 910 and or via disposal wells 906 into an aquifer 912 as a diluted calcium bicarbonate solution. A second product of the AWL reactor is flue gases minus most of the carbon dioxide, sulphur and NOxs which can be vented from the in-situ AWL reactor 914 into the surrounding atmosphere.

The advantage of the in-situ configuration of FIG. 9 is that the limestone can be crushed by any number of excavating means and most of the crushed limestone need not be moved. That is, the material handling operations, and hence costs, can be minimized.

### Water Management

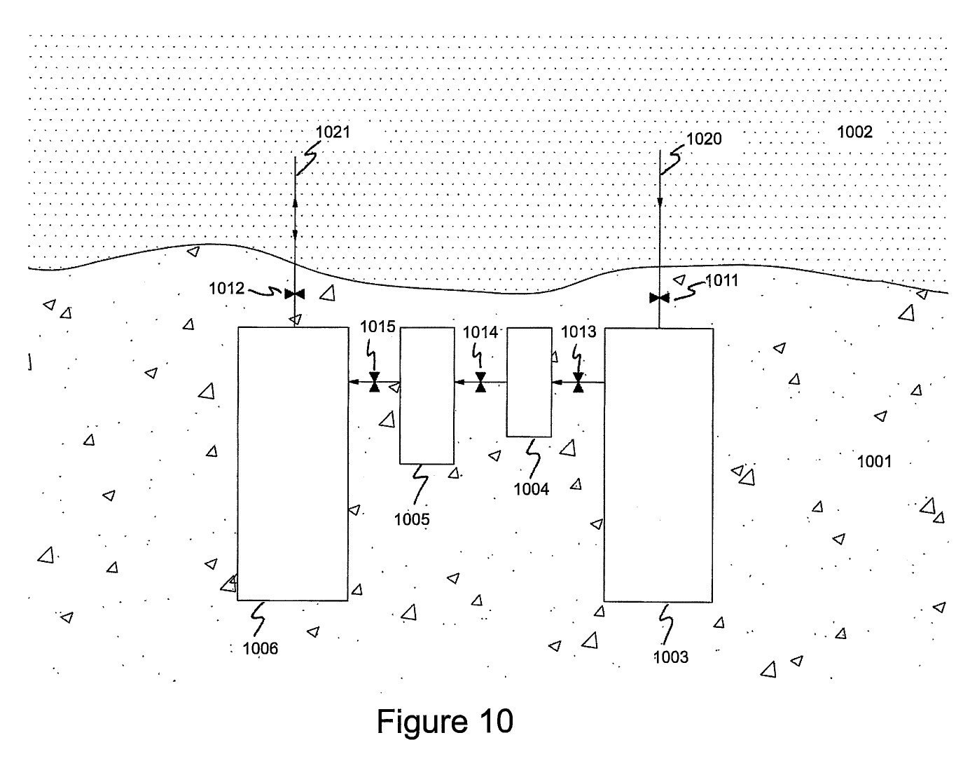

As is known, the cost of pumping millions of gallons of water vertically even for only a few meters can be a significant cost factor. Siting an AWL facility near an ocean in underground caverns can utilize the tides to fill a water chamber with sea water and then flush the calcium bicarbonate solution, formed in one or more AWL reactors, back into the ocean. FIG. 10 is a plan view of a two-stage AWL reactor operation utilizing tidal action to move large amounts of sea water. Here an underground AWL facility is sited near an ocean 1002 where there is significant tidal variation. A first large underground cavern 1003 is used to collect sea water during incoming tides by opening gate 1011. The water in cavern 1003 is then sent to a first underground reactor 1004 as needed by opening gate 1013. Flue gases are introduced into reactor 1004 where carbonic acid is formed. The carbonic acid is then sent to a second underground reactor 1005 as needed by opening gate 1014. Crushed limestone and limestone fines are introduced into reactor 1005 where a calcium bicarbonate solution is formed. The calcium bicarbonate solution is then sent to underground cavern 1006 by opening gate 1015. A second large underground cavern 1006 is also used to collect sea water during incoming tides by opening gate 1012. The water in cavern 1006 is used to dilute the calcium bicarbonate solution in preparation for discharging into the ocean. The discharge takes place during outgoing tides by opening gate 1012.

It is also possible to use a single cavern to bring in sea water, use the sea water in an underground AWL reactor system and then return the calcium bicarbonate solution to the cavern where the calcium bicarbonate solution can be diluted and flushed into the sea with the outgoing tide.

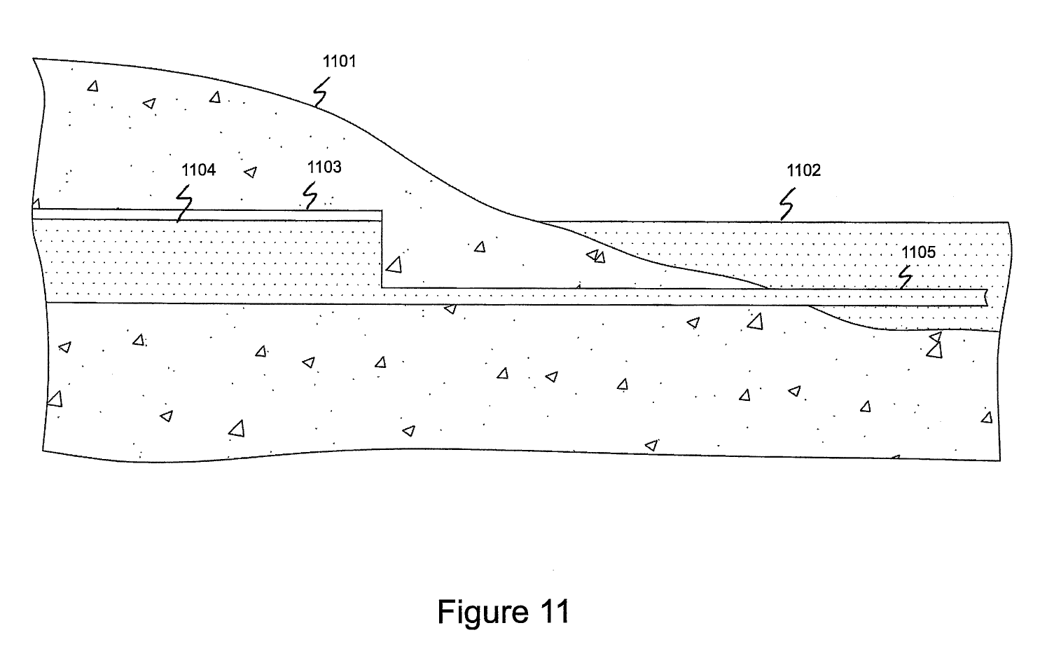

FIG. 11 is a side view of an AWL reactor facility at high tide. This figure shows a large cavern 1103 excavated near the shore 1101 which is designed to substantially fill with sea water 1104 at high tide in ocean 1102. Sea water enters cavern 1104 via one of more conduits 1105. The cavern is sufficiently large enough to provide water for an AWL reactor system until the next high tide. Water flow control gates are not shown.

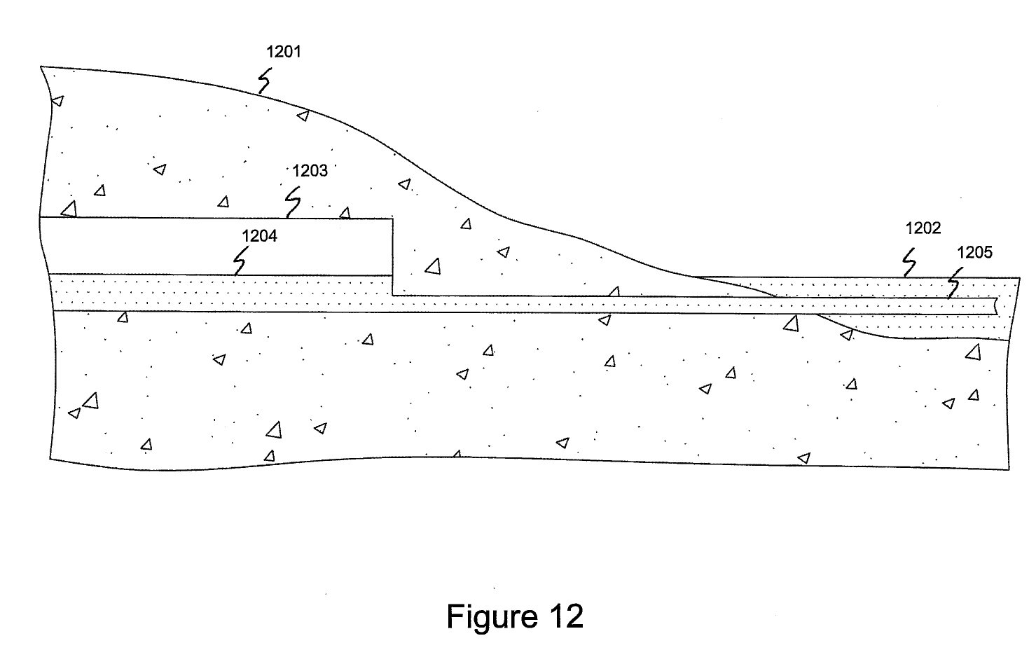

FIG. 12 is a side view of an AWL reactor facility at low tide. This figure shows a large cavern 1203 which is designed to substantially empty of sea water 1204 at low tide in ocean 1202. Sea water exits cavern 1204 via one of more conduits 1205. Water flow control gates are not shown. As discussed in FIG. 11, the cavern can be either of caverns 1103 or 1106 in FIG. 10.

### Disposal of Previously Captured Carbon Dioxide by AWL

Carbon dioxide may be captured by conventional means which include pre-combustion systems such as catalytic reforming and water shifting that produces carbon dioxide that can be captured by a number of well-known methods; post-combustion systems where carbon dioxide is separated from flue gases by a number of well-known methods; oxyfuel combustion where carbon dioxide is separated from flue gases enriched in carbon dioxide by a number of well-known methods; and other industrial processes such as ammonia production that produces carbon dioxide that can be captured by a number of well-known methods.

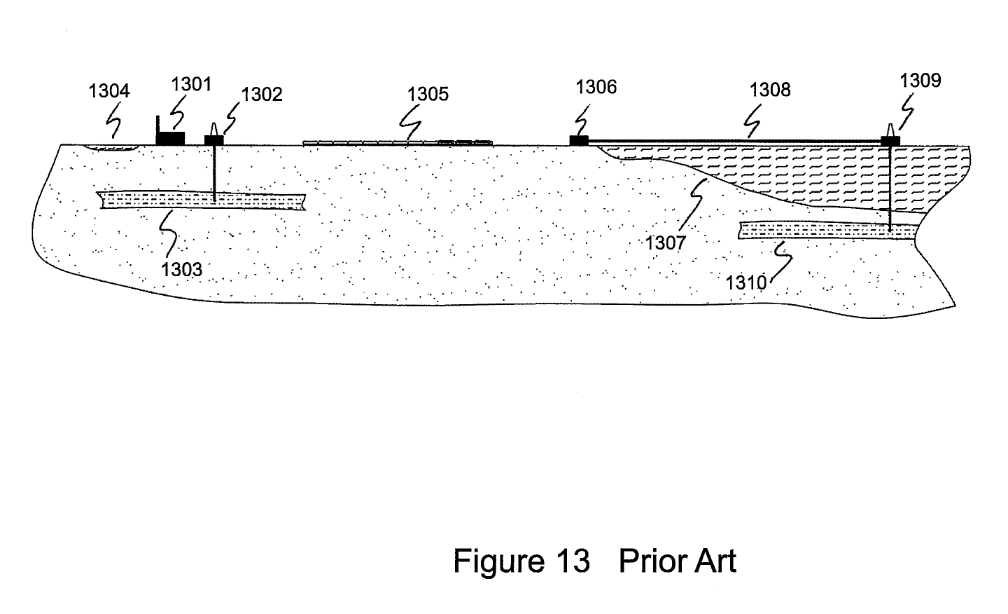

FIG. 13 is a schematic of a prior art system for disposing of previously captured carbon dioxide. This figure depicts an industrial operation 1301 that captures carbon dioxide by conventional means prior to emitting flue gases. This captured carbon dioxide may be sequestered at a nearby sequestration facility 1302 in any number of appropriate deep geological reservoirs or structures 1303. Geological reservoirs include depleted gas and oil fields, saline formations and the like) and geological structures include abandoned mines. It is typically not sequestered in nearby rivers or lakes 1304 as carbon dioxide will cause acidification of the water. If a nearby sequestration facility 1302 is not available or too expensive, the captured carbon dioxide can be transported by train, truck or pipeline for sequestration in an ocean 1307. For example, the carbon dioxide may be shipped by rail 1305 and off-loaded at a transfer station 1306 for transport to an off shore platform by pipeline 1308, or by ship or barge. The carbon dioxide can then be sequestered in a deep geological reservoir 1310 under the ocean floor or sequestered in the deep ocean. Sequestering carbon dioxide in deep geological reservoirs 1303 may be expensive because of the cost of deep drilling and because of the uncertainties of the containment ability of the reservoir. Thus it may be preferable to transport the carbon dioxide for sequestration under an ocean because the greater cost is justified by removing many of the uncertainties of the containment ability of the reservoir.

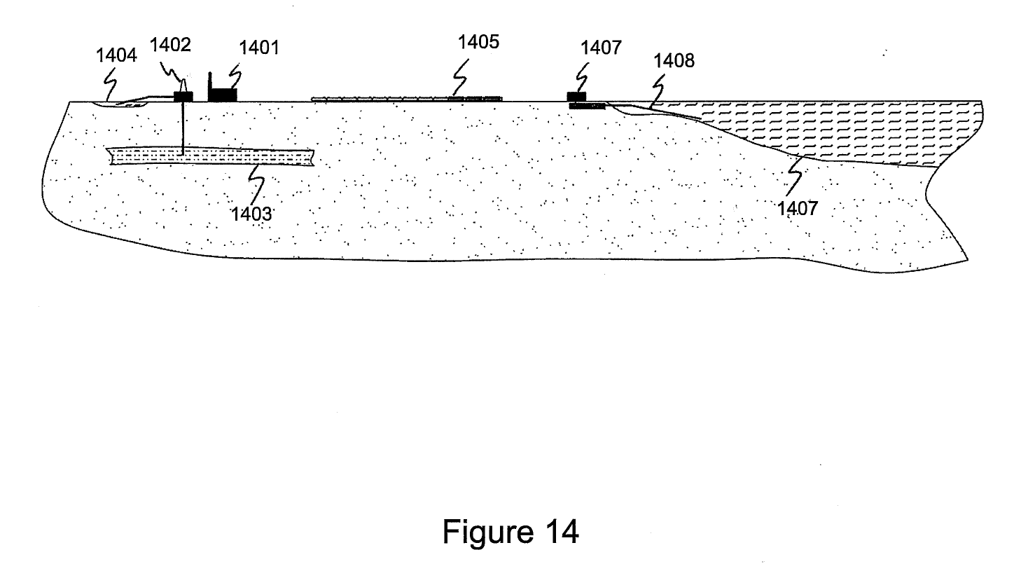

FIG. 14 is a schematic of an AWL system for disposing of previously captured carbon dioxide which reduces both cost and uncertainty of disposing of previously captured carbon dioxide. This figure depicts an industrial operation 1401 that captures carbon dioxide by conventional means prior to emitting flue gases. This captured carbon dioxide may be sequestered in an appropriate deep aquifer 1403 or in an appropriate nearby river or lake 1404 from a carbon dioxide sequestration facility 1402. If a nearby sequestration site is not available, the captured carbon dioxide can be transported by train, truck or pipeline for sequestration in an ocean 1409. For example, the carbon dioxide may be shipped by rail 1405 and off-loaded at an AWL facility 1406 where additional sea water can be added to dilute the concentrated calcium bicarbonate solution which can then be disposed by pipeline 1408 directly into the ocean 1407. As noted previously, the net effect of this addition of calcium bicarbonate is to slightly raise the alkalinity of the sea water. This is beneficial when the sea water is slightly acidic as is the case when large amounts of carbon dioxide are sequestered in the oceans either by natural causes or dumping of carbon dioxide.

A number of variations and modifications of the inventions can be used. As will be appreciated, it would be possible to provide for some features of the inventions without providing others. For example, though the embodiments are discussed with reference to use of crushed limestone, it is to be understood that the various embodiments may be used with other types of naturally occurring rocks such as dolomite, peridotite and the like. Dolomite is thought to be somewhat more active than limestone in the uptake of carbon dioxide. Peridotite is known to be very active in absorbing carbon dioxide although it is not as commonly found as limestone or dolomite. As can be appreciated, combinations of limestone, dolomite and peridotite may give rise to a faster carbon dioxide uptake reaction or a more complete carbon dioxide uptake reaction.

The present invention, in various embodiments, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
receiving, from a hydrocarbon-powered industrial operation, a carbon dioxide-containing off-gas;
contacting the off-gas with water and an underground supply of carbonate mineral-containing materials to convert at least a portion of the carbon dioxide and carbonate mineral-containing materials into aqueous bicarbonate and a treated off-gas; and
discharging the treated off-gas.

2. The method of claim 1, wherein at least about 20% of the carbon dioxide in the off-gas is converted into an aqueous bicarbonate, wherein the hydrocarbon-powered industrial operation is at least one of a power plant, a cement production plant, a steel production plant, and a thermal hydrocarbon recovery operation, wherein the off-gas further comprises carbon monoxide, sulfur, and nitrogen oxides, and wherein the aqueous bicarbonate is discharged into a large body of water.

3. The method of claim 1, wherein the contacting step comprises:
in a first underground zone dissolving at least part of the off-gas in water; and
in a second underground zone contacting the dissolved off-gas with carbonate mineral-containing materials to form the aqueous bicarbonate and treated off-gas, the first and second underground zones being spatially dislocated from one another.

4. The method of claim 1, wherein the underground carbonate mineral-containing materials supply is from and in spatial proximity to an underground carbonate mineral-containing materials deposit, wherein water is transported to the underground carbonate mineral-containing materials supply from at least one of an underground aquifer, a surface body water, and the operation, wherein the aqueous bicarbonate is discharged into at least one of an underground aquifer, a surface body of water, and an underground excavation, and wherein the treated off-gas is discharged into the atmosphere.

5. The method of claim 4, wherein the carbonate mineral-containing materials in the underground carbonate mineral-containing materials supply is from the underground carbonate mineral-containing materials deposit, wherein the carbonate containing material is at least one of limestone and dolomite and wherein the carbonate mineral-containing materials is comminuted in situ to form particulated carbonate mineral-containing materials for contact with the carbon dioxide in the off-gas.

6. The method of claim 1, wherein the underground supply of carbonate mineral-containing materials is an in situ deposit of carbonate mineral-containing materials and wherein the carbonate containing material is at least one of limestone and dolomite.

7. The method of claim 1, further comprising:
in a first mode at high tide, collecting water in at least one underground excavation, wherein at least a portion of the water in the contact step is the collected water;
after removal of at least a portion of the collected water, discharging at least a portion of the aqueous bicarbonate into the at least one underground excavation; and
in a second mode at low tide, discharging the at least a portion of the aqueous bicarbonate from the at least one underground excavation and into an ocean.

8. The method of claim 1, wherein an accelerated weathering of carbonate mineral-containing materials (“AWC”) reactor is positioned underground and wherein the AWC reactor performs the contacting step.

9. The method of claim 8, further comprising:
collecting, in response to tidal action, water in at least a first underground excavation;
transporting the collected water to the AWC reactor; and
transporting the aqueous bicarbonate to the at least a first underground excavation for removal by tidal action.

10. The method of claim 9, wherein the at least a first underground excavation comprises a first underground excavation for collection of water from tidal action and a second underground excavation for holding the aqueous bicarbonate for removal by tidal action.

11. A system, comprising:
a supply of carbonate mineral-containing materials;
an inlet for a carbon dioxide-containing off-gas from a hydrocarbon-powered industrial operation, the hydrocarbon-powered industrial operation converting hydrocarbons into the off-gas;
an accelerated weathering of carbonate mineral-containing materials (“AWC”) reactor to contact the off-gas with water and carbonate mineral-containing materials to convert at least a portion of the carbon dioxide and carbonate mineral-containing materials into aqueous bicarbonate and a treated off-gas, the AWC reactor being positioned underground; and
an outlet to discharge the treated off-gas.

12. The system of claim 11, wherein the supply of carbonate mineral-containing materials is positioned underground near the hydrocarbon-powered industrial operation, wherein at least about 20% of the carbon dioxide in the off-gas is converted into carbonic acid, wherein the hydrocarbon-powered industrial operation is at least one of a power plant, a cement production plant, a steel production plant, and a thermal hydrocarbon recovery operation, wherein the off-gas further comprises carbon monoxide, sulfur, and nitrogen oxides, wherein the industrial operation and AWC reactor are located on a common site, and wherein the aqueous bicarbonate is discharged into a large body of water.

13. The system of claim 11, wherein the AWC reactor comprises:
a first underground zone to dissolve at least part of the off-gas in water; and
a second underground zone to contact the dissolved off-gas with carbonate mineral-containing materials to form the aqueous bicarbonate and treated off-gas, the first and second underground zones being spatially dislocated from one another and the second underground zone comprising more carbonate mineral-containing materials than the first underground zone.

14. The system of claim 13, wherein the first underground zone is substantially free of carbonate mineral-containing materials and wherein at least most of the off-gas is contacted with water in the first underground zone.

15. The system of claim 11, wherein the carbonate mineral-containing materials is from and in spatial proximity to an underground carbonate mineral-containing materials deposit, wherein the off-gas is transported to the AWC reactor, wherein water is transported to the AWC reactor from at least one of an underground aquifer, a surface body water, and the operation, wherein the aqueous bicarbonate is discharged into at least one of an underground aquifer, a abandoned underground excavation, and a surface body of water, and wherein the treated off-gas is discharged into the atmosphere.

16. The system of claim 15, wherein the carbonate mineral-containing materials in the underground carbonate mineral-containing materials supply is from the underground carbonate mineral-containing materials deposit, wherein the carbonate containing material is at least one of limestone and dolomite and wherein the carbonate mineral-containing materials is comminuted in situ to form particulated carbonate mineral-containing materials for contact with the carbon dioxide in the off-gas.

17. The system of claim 11, wherein the carbonate mineral-containing materials is an in situ deposit of carbonate mineral-containing materials, wherein the carbonate containing material is at least one of limestone and dolomite.

18. The system of claim 17, wherein at least some of the carbonate mineral-containing materials has been comminuted to form a particulated carbonate mineral-containing materials material and wherein the aqueous bicarbonate is sequestered in an underground excavation.

19. The system of claim 11, further comprising:
at least a first underground excavation to collect, in response to tidal action, water and contain the aqueous bicarbonate for removal by tidal action.

20. The system of claim 19, wherein the at least a first underground excavation comprises separate excavations for collecting water and containing the aqueous bicarbonate.

21. The system of claim 11, wherein the industrial operation and AWC reactor are located remotely from one another, wherein the industrial operation and AWC reactor are not located on a common site, and wherein the aqueous bicarbonate is discharged into the ocean.

22. A reactor assembly, comprising:
(a) a first zone to contact water with a carbon dioxide-containing off-gas to dissolve at least about 20% of the carbon dioxide in the water to form a treated off-gas and an aqueous process stream comprising dissolved carbon dioxide in the form of carbonic acid, the first zone being substantially free of carbonate mineral-containing materials; and
(b) a second zone to contact the process stream with carbonate mineral-containing materials to convert at least about 20% of the carbonic acid to a bicarbonate and form aqueous bicarbonate, wherein the first and second zones are spatially dislocated from one another.

23. The reactor assembly of claim 22, further comprising:
(c) a first recycle loop, the first recycle loop recycling a first portion of the aqueous process stream to the first zone where the first portion is sprayed into the off-gas; and
(d) a first outlet from the first zone to input a second portion of the aqueous process stream to the second zone.

24. The reactor assembly of claim 22, further comprising:
(c) a second recycle loop, the second recycle loop recycling a first portion of the aqueous bicarbonates to the second zone where the first portion is sprayed into a space above the aqueous process stream; and
(d) a second outlet from the second zone to discharge a second portion of the aqueous bicarbonates.

25. A method, comprising:
at high tide, collecting seawater in at least a first excavation;
at low tide, removing the collected seawater from the at least a first excavation;
processing the seawater to form a discharge stream; and
at low tide, locating the discharge stream in the at least a first excavation, whereby, at high tide, the discharge stream is removed from the at least a first excavation.

26. The method of claim 25, wherein, at high tide, the discharge stream is replaced in the at least a first excavation by collected seawater.

27. The method of claim 25, wherein the discharge stream comprises a bicarbonate.

28. The method of claim 27, wherein the bicarbonate in the discharge stream is from contact, in an accelerated weathering of carbonate mineral-containing materials reactor, of carbonate mineral-containing materials with a carbon dioxide-containing fluid.

29. The method of claim 28, wherein the carbon dioxide-containing fluid is an off-gas from an industrial operation.

30. The method of claim 25, wherein the at least a first underground excavation comprises separate excavations for collecting water and containing the discharge stream.

31. A method, comprising:
in a first zone, contacting water with a carbon dioxide-containing off-gas to dissolve at least about 20% of the carbon dioxide in the water to form a treated off-gas and an aqueous process stream comprising dissolved carbon dioxide in the form of carbonic acid, the first zone being substantially free of carbonate mineral-containing materials; and
in a second zone, contacting the process stream with carbonate mineral-containing materials to convert at least about 20% of the carbonic acid to a bicarbonate and form aqueous bicarbonates, wherein the first and second zones are spatially dislocated from one another.

32. The reactor assembly of claim 31, further comprising:
by a first recycle loop, recycling a first portion of the aqueous process stream to the first zone where the first portion is sprayed into the off-gas; and
by a first outlet from the first zone, inputting a second portion of the aqueous process stream to the second zone.

33. The reactor assembly of claim 31, further comprising:
by a second recycle loop, recycling a first portion of the aqueous bicarbonates to the second zone where the first portion is sprayed into a space above the aqueous process stream; and
by a second outlet from the second zone, discharging a second portion of the aqueous bicarbonates.

34. A system, comprising:
at least a first underground excavation operable, at high tide, to collect seawater; and
a facility operable, at low tide, to remove the collected seawater from the at least a first excavation; process the seawater to form a discharge stream; and, at low tide, to locate the discharge stream in the at least a first excavation, whereby, at high tide, the discharge stream is removed from the at least a first excavation.

35. The method of claim 34, wherein, at high tide, the discharge stream is replaced in the at least a first excavation by collected seawater.

36. The method of claim 35, wherein the discharge stream comprises a bicarbonate.

37. The method of claim 36, wherein the facility is a gas treatment facility comprising an accelerated weathering of carbonate mineral-containing materials (“AWC”) reactor, wherein the bicarbonate in the discharge stream is from contact, by the AWC reactor, of carbonate mineral-containing materials with a carbon dioxide-containing fluid.

38. The method of claim 37, wherein the carbon dioxide-containing fluid is an off-gas from an industrial operation.

39. The method of claim 34, wherein the at least a first underground excavation comprises separate excavations for collecting water and containing the discharge stream.
